(19) United States
(12) Patent Application Publication
(10) Pub. No.: US 2026/0045786 A1
(43) Pub. Date: Feb. 12, 2026

(54) SUPPLY DEVICE FOR SUPPLYING POWER TO A LOAD MODULE

(71) Applicant: Dräger Safety AG & Co. KGaA, Lübeck (DE)

(72) Inventor: Martin Schulze, Lübeck (DE)

(21) Appl. No.: 19/292,184

(22) Filed: Aug. 6, 2025

(30) Foreign Application Priority Data
Aug. 8, 2024 (DE) 102024122647.1

(51) Int. Cl. H02H 9/00; H02H 1/00; H02H 9/02

(52) U.S. Cl. CPC H02H 9/008; H02H 1/0007; H02H 9/02

(57) ABSTRACT

A load module for supplying a load may comprise an input terminal for coupling to a power supply and an output terminal for coupling to the load. A switching device may serve for the variable electrical coupling of the input terminal to the output terminal. A control unit coupled to the switching device may be designed to control an electrical coupling of the input terminal to the output terminal after the load module has been coupled to a power supply, via the switching device.

### CROSS-REFERENCE TO RELATED APPLICATIONS

This application claims the priority of German Patent Application No. 102024122647.1, filed on Aug. 8, 2024, and titled “SUPPLY DEVICE FOR SUPPLYING POWER TO A LOAD MODULE”, which is hereby incorporated by reference in its entirety for all nonlimiting purposes.

### BACKGROUND

The present invention relates to the supply of power to loads, for example loads located in potentially explosive atmospheres.

For example, transmitters in sensor heads or transmitters for communication with sensor heads for measuring flammable and explosive gases are used in many parts of the industry to detect flammable, toxic and explosive gases at an early stage. The aim of this detection is to evacuate regions in a timely manner or to initiate appropriate countermeasures. These include, for example, acoustic and visual alarms as well as the initiation of forced ventilation or the shutdown of certain systems. Some of these transmitters are also used in process measurement technology and are part of the control chain in the petrochemical industry. An entire system for measuring gases usually consists of a control unit, a barrier module and the actual transmitter. The transmitter often transmits the measured value to the control unit via a current loop (4-20 mA interface) by injecting a current into the line depending on the actual measured value. In such 2-wire transmitters, the device is often powered by the impressed current of the current loop.

The transmitter supplies power to a remote measuring head and communicates with it. From the transmitter's perspective, the remote measuring head is then a load that it supplies with power. Such a transmitter also serves as a power supply device for the load generated by the remote sensor head. The remote sensor head itself in turn contains a transmitter for communication with the transmitter of the supply device. Since communication and power supply are carried out via the same cables, it is located between the power supply device and the sensor itself, which is also supplied with current via the cables. This transmitter can therefore also be considered as a load module to supply a load, in particular to supply power to the sensor.

These transmitters are used under very different environmental conditions. They can also be positioned in environments with the potentially explosive gases or dusts, which place particular demands on the components used. In order to ensure explosion protection, two reasons for potential ignition must be excluded (e.g., prevented). The first reason is spark ignition, usually prevented by limiting the energy released in the event of a fault, and spontaneous ignition, prevented by a temperature limit.

A similar application of the power supply concerns pumps that are used in stationary gas measurement technology to draw a small amount of gas from a system or pipe and transport it to a sensor. Pump applications are often characterized by the fact that the sampling takes place in a very inaccessible space and the gas is transported through hoses or pipes over a longer distance to the actual measuring point. Since such pumps are often used in regions with explosive atmospheres and also pump gas mixtures that are potentially flammable, there are increased requirements in the design of such pumps to ensure that they do not themselves become an ignition source.

Also when used as a power supply for pumps in such atmospheres, it is therefore necessary to design the power supply of the pump module in such a way that it cannot serve as an ignition source.

DE 11 2011 101 763 T5 discloses a system for supplying power to a branch line in a fieldbus system, comprising a current measuring device, a drive unit and a processing device which controls the current based on the measurement.

DE 20 2019 000 194 U1 discloses a circuit for reducing inrush currents by switching on consumers at different times after a supply voltage has been applied.

### SUMMARY

In summary, there is a need to ensure that loads or devices are supplied with power in such a way that the power supply does not constitute an ignition source even in the event of a fault.

This requirement is met by a load module and by the corresponding method described herein.

In this case, some of the embodiments are based on the finding that it is possible, by means of a suitable design of the supply device serving as the power source and by means of the load module, to prevent such large amounts of power from being able to be released such that, even in the event of a malfunction, this would create an ignition source.

Also disclosed is a supply device for supplying power to a load module comprising an input terminal for coupling to a power supply and an output terminal for supplying power to the load module. A measuring device is used to measure a current consumption via the input terminal, and a drive unit is used to control a current via the output terminal. A control unit is coupled to the measuring device and the drive unit and is configured to control the current via the output terminal based on the current consumption via the input terminal. If the current is controlled, the amount of energy can, for example, be limited so that even in the event of a fault, such as a short circuit in the lines fed by the supply device, it is not sufficient to ignite a medium in the vicinity of the lines or in the environment of an entire system.

According to some embodiments, the control unit is designed for this purpose to limit the current via the output terminal.

According to some embodiments, the control unit is designed to limit the current via the output terminal when a threshold value of the current consumption via the input terminal is exceeded.

According to some embodiments, the control unit is designed to control an electrical coupling of the input terminal to the output terminal via the drive unit. The coupling control can, for example, be used to limit the current between the input terminal and the output terminal as required rather than switching it off completely, so that operation can optionally continue even if the current consumption would be outside a desired range without coupling control.

According to some embodiments, the control unit is designed to interrupt an electrical coupling of the input terminal to the output terminal via the drive unit in order to ensure, for example, maximum safety.

In addition, according to some examples, the supply device can be encapsulated in a flameproof manner, so that it is additionally protected even in the event of a fault.

According to the present disclosure, the load module for supplying a load comprises an input terminal for coupling to a power supply and an output terminal for coupling to the load. A switching device is used for the variable electrical coupling of the input terminal with the output terminal. A control unit is coupled to the switching device and designed to control an electrical coupling of the input terminal to the output terminal after coupling of the load module to a power supply, via the switching device. The possibility of control can be used to prevent currents from flowing which are of such a nature that they pose an ignition risk.

According to the present disclosure, the control unit is designed to allow a current flow by means of a switched transistor only in one direction. This can, for example, prevent the flow of charge transfer currents in the event of a malfunction that could be so large that they could lead to the ignition of a gas mixture, for example at the location of a short circuit in a supply line.

According to some embodiments, the control unit is designed to delay an electrical coupling of the input terminal to the output terminal after the coupling to the power supply has taken place, via the switching device. This can prevent starting currents of machines or charging currents of capacitors from exceeding a critical current strength after coupling to a power supply.

According to some embodiments, the control unit is configured to perform the delayed electrical coupling of the input terminal to the output terminal based on a charge state of a capacitor. The use of a suitably large capacitor can, for example, be used to determine when the capacitors of a load are charged, so that in the case of a low-impedance connection between the input terminal and the output terminal, high charging currents no longer occur.

Optionally, the capacitor can therefore be charged via a limited current after being coupled to the power supply.

According to some embodiments, this can be achieved robustly and efficiently by bridging the switching device with an electrical resistor to charge the capacitor.

According to some embodiments, the control unit is designed to switch the switching device to high impedance when the coupling to the power supply occurs, and to switch the switching device to low impedance when the capacitor voltage exceeds a predefined threshold value. If the switching device becomes low-impedance after the initial charging of the capacitor, a line length for connecting the load module can be extended compared with the case where the high-impedance remains, at least initially, for safety reasons.

### BRIEF DESCRIPTION OF THE DRAWINGS

Some examples of devices and/or methods are explained in more detail below with reference to the accompanying drawings, in which:

FIG. 1 is a block diagram of an example of a supply device;

FIG. 2 is a block diagram of the supply device of FIG. 1 and an embodiment of a load module;

FIG. 3 shows a further example embodiment of a load module with the supply device of FIG. 1;

FIG. 4 is a flowchart of an example embodiment of a method for supplying power to a load module; and

FIG. 5 is a flowchart of an embodiment of a method for controlling a load.

### DETAILED DESCRIPTION

Various examples will now be described in more detail with reference to the accompanying figures. In the figures, the thicknesses of lines, layers and/or regions may be exaggerated for clarity.

Further examples may cover modifications, equivalents, and alternatives that fall within the scope of the disclosure. The same or similar reference signs refer to the same or similar elements throughout the description of the figures, which, when compared with one another, may be implemented identically or in a modified form while providing the same or a similar function.

It is understood that when an element is referred to as being “connected” or “coupled” to another element, the elements may be connected or coupled directly or through one or more intermediate elements. When two elements A and B are combined using an “or”, this should be understood to disclose all possible combinations, i.e., only A, only B, and both A and B, unless explicitly or implicitly defined otherwise. An alternative formulation for the same combinations is “at least one of A and B” or “A and/or B.” The same applies, mutatis mutandis, to combinations of more than two elements.

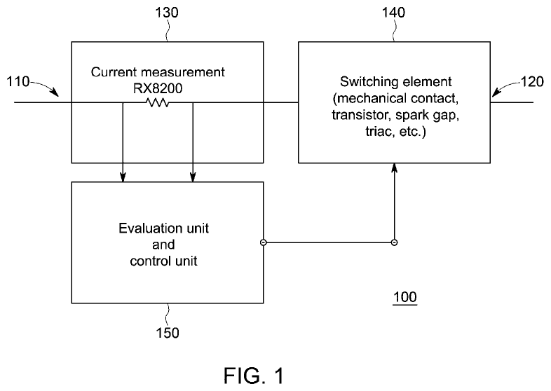

FIG. 1 shows a block diagram of an example of a supply device 100 for supplying power to a load module.

This has an input connection 110 for coupling to a power supply and an output connection 120 for supplying power to the load module. Power input and output terminals can be designed in different ways depending on the specific requirements of the application. For example, these can be designed in the form of a standard plug for device connections (e.g., cold device connection IEC 60320) or as a Schuko plug. Other options include mains supply plugs, such as round plugs for different voltages. Jack plugs, screw terminals or spring-loaded terminals are also possible, however. Banana plugs and modular connectors, which can be plugged together in many configurations, are another way to implement these connections.

The supply device 100 further comprises a measuring device 130 for measuring a current consumption via the input terminal 110, and a drive unit 140 for controlling a current via the output terminal 120. The current can be measured in different ways depending on the application. Examples would be the use of a shunt resistor, a current mirror, Hall effect sensors or an integrated current measuring IC.

For control purposes, i.e., for example for limiting or switching off current, various methods for controlling the current flow in a circuit or for switching it on and off can be implemented in the drive unit 140. For example, relays can be used. Electromechanical relays use an electromagnetic circuit to control larger currents, while solid-state relays (SSRs) operate without moving parts and are therefore faster and more durable. Transistors, such as bipolar transistors (BJTs) and field-effect transistors (FETs), are also widely used electronic switches. They can switch large load currents using small control currents, with MOSFETs often being used in digital circuits. For higher voltages and currents, IGBT (insulated gate bipolar transistor) and GTO (gate turn-off thyristor) are suitable. Thyristors, such as the silicon controlled rectifier (SCR) and the Triac, offer robust solutions for switching alternating current, especially in dimmers and other controls.

A control unit 150 is coupled to the measuring device 130 and the drive unit 140 and is configured to control the current via the output terminal 120 based on the current consumption via the input terminal 110. The control unit 150 receives measured values that indicate the current flow and controls the drive unit 140. The control unit 150 implements logics to control the current flow. The logics could be implemented using a variety of technologies. One of the basic technologies for this would be discrete logic gates, which consist of transistors and implement simple logical functions such as AND, OR and NOT. Another form of logics implementation is integrated circuits (ICs), such as in the form of TTL (transistor-transistor logic) and CMOS (complementary metal-oxide-semiconductor). Programmable logic devices such as FPGAs (field-programmable gate arrays) can be used for customizable logic circuits. Another way to implement these logics is to use microcontrollers and microprocessors. Specialized ICs, such as application-specific integrated circuits (ASICs), which are specifically designed for a particular application or set of tasks, can also be used for this purpose.

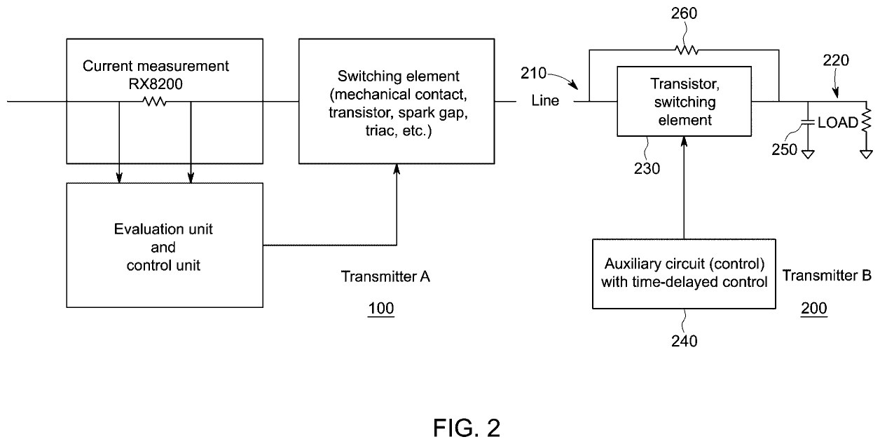

FIG. 2 shows a block diagram of the supply device 100 of FIG. 1 and an embodiment of a load module 200 connected to a supply device 100.

The load module 200 is used to supply power to a load and, in some examples, also to communicate with the supply device 100 via the line or lines that carry the power. In this function, the load module 200 can also be understood as a transmitter.

The load module 200 has an input terminal 210 for coupling to a power supply and an output terminal 220 for coupling to the load. A switching device 230 serves for the variable electrical coupling of the input terminal 210 to the output terminal 220. A control unit 240 is coupled to the switching device 230 and is designed to control an electrical coupling of the input terminal 210 to the output terminal 220 via the switching device 230 after the load module 200 is coupled to a power supply (for example the supply device 100).

For example, those technologies discussed for the drive unit 140 with reference to FIG. 1 can be used as technologies for implementing the switching device 230. For example, those technologies discussed for the drive unit 150 with reference to FIG. 1 can be used as technologies for implementing the control unit 240.

The coupling to the power supply can be detected in any way, for example by measuring a voltage or a current at the input terminal 210. The coupling can also be determined implicitly, for example the coupling may be assumed when logics in the control unit 240 are first supplied with power and begin to operate. In principle, mechanical detection is also possible, which is triggered, for example, by plugging in a power plug.

In the embodiment shown in FIG. 2, the control unit 240 is designed to delay an electrical coupling of the input terminal 210 to the output terminal 220 after the coupling to the power supply via the switching device 230 has taken place. This makes it possible to ensure that immediately after the start of the power supply, starting currents or charging currents of capacitors do not lead to powers that are no longer acceptable for explosion protection being transmitted via the lines. This allows higher currents to then be transmitted than in the case of conventional solutions that maintain the current limitation throughout the entire operating period, for example by means of a resistor. Alternatively, the lower power loss can also be exploited by allowing the length of the supply line to the load module 200 to be considerably longer than in conventional implementations.

In the case shown in FIG. 2, the coupling of the input terminal 210 to the output terminal 220 is performed based on a charge state of the capacitor 250. After being coupled to the power supply, the capacitor 250 is initially charged with a limited current via the resistor 260, which bridges the switching device 230. During this time, the switching device 230 separates the input terminal 210 from the output terminal 220. When the capacitor 250 reaches a specified charge state (for example measured by the voltage drop across the capacitor), the switching device 230 connects the input terminal 210 to the output terminal 220. Alternatively, the delay can also be implemented differently, for example by waiting a certain time.

In more general terms, the concept of the load module 200 of FIG. 2 can be described in such a way that the control unit is designed to switch the switching device 230 to a high impedance when the coupling to the power supply takes place, and to switch the switching device 230 to a low impedance when the capacitor voltage exceeds a predefined threshold value.

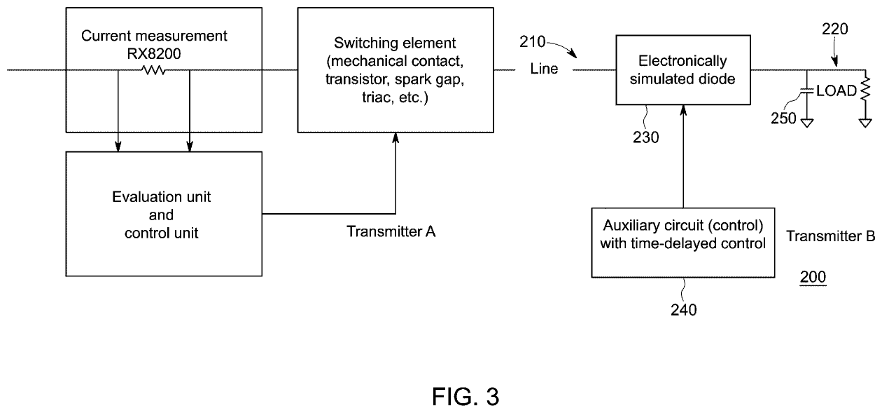

FIG. 3 shows a further embodiment of a load module 200, which corresponds in large parts to the embodiment shown in FIG. 2. Therefore, identical components are also provided with the same reference signs. Unlike the case described in FIG. 2, the control unit 240 is additionally or alternatively designed to allow a current flow in only one direction. For example, it is thus possible to prevent transfer currents in the load module 200 or in the load connected to it being able to lead to sparking, in the event of a short circuit in the line to the input terminal 210. In this case, for example a current flow into the input terminal 210 is allowed, but in the case of a possible current flow out of the input terminal 210, the input terminal 210 is separated from the output terminal 220. In this case, the direction of current flow can be measured in any known way.

As explained above, possible loads that are supplied by or connected to the load module can be pump modules or measuring heads for gases. However, this concept is not limited to that. Rather, any loads can be fed or operated with the load modules described here.

In other words, FIG. 2 and FIG. 3 each show two spatially separated parts for power supply.

The supply device 100 is a transmitter A, which can also maintain a connection (not shown) to a control unit of the system. The load module 200 can also be considered as a transmitter B/measuring head, which is connected to transmitter B via a wiring remote from transmitter A.

On side A, a current measurement is carried out by a circuit. The control can be carried out by an auxiliary circuit that evaluates the current measurement. A threshold switch is integrated into the evaluation unit. If a threshold value corresponding to the application is exceeded, the control unit switches off the switching element arranged downstream of the current measurement. Switching off the switching element counteracts the increase in current. In this case, it is not important whether the switching is in the form of a normally closed contact or exists in the form of a linearly controllable current limitation.

In the case shown in FIG. 3, an electronic circuit is integrated in the transmitter B, that allows the current of the supply line to pass in only one direction. It could optionally also be bridged by a resistor that allows a certain base current. In this case, an auxiliary circuit could take over the function of the control and ensure that the switching device 230, e.g., a transistor used in it, behaves like a diode, i.e., only allows the current to pass in one direction, but with a much lower voltage drop, thereby achieving the high energy efficiency.

In the case shown in FIG. 2, the state of the logics of the control unit 240 is selected such that the switching element does not allow any current to pass. If the operating voltage is now switched on, the current is initially determined only by the bridging resistor. In the specific implementation, the current-limiting component can be a resistor, an inductor or a partially turned-on transistor, as well as any combination of these components. This current is usually an order of magnitude smaller than the current limitation set in the transmitter A.

The limited current can now charge the charge storage of the connected load until the switching point is reached. This switches the switching element or switching device 230 with a time delay. This allows a low-impedance connection and thus almost loss-free transmission between transmitter A and transmitter B.

Alternatively, the current-limiting component and the switching element can be one and the same transistor, which is first partially turned on to limit the current and then fully turned on. It is also possible that this transition will not be carried out in stages, but continuously.

This embodiment of the invention results in a reduction in the transfer current by orders of magnitude compared to conventional implementations. This can, for example, protect fuses from being accidentally triggered. This not only prevents spark ignition but also provides a soft start. This allows the connection of high capacitive loads, which could otherwise cause the electronic fuse to be accidentally triggered.

This concept makes it possible to connect two transmitters in a potentially explosive region while maintaining high energy efficiency and avoiding sparking. Any short circuits in the cable will not result in spark ignition. The possible length of the connection is also significantly increased. With conventional approaches to spark protection, the cable length between transmitter A and transmitter B in similar applications is significantly reduced due to the actual inductance of the cable under the same conditions.

This can also significantly reduce the requirements for the cables to be used and the planning of systems, resulting in lower system costs. For example, cables could be routed through potentially explosive regions without having to meet standard insulation thicknesses to prevent internal short circuits.

This applies in particular to typical use cases of the described architecture. In confined installation spaces, a transmitter A is often installed in an accessible location, which also serves as a measured value display. At the same time, this transmitter A is connected to the central unit (control unit). This transmitter A can receive one or more measurement channels and thus connections to the control unit. Often, another transmitter B is connected via a proprietary bus system that also includes the power supply of a remote measuring head.

These remote measuring heads with transmitter B are usually installed in extremely inaccessible locations and often do not have their own measured value display. In the case of conventional solutions, the installation length between the remote transmitter B (measuring head) described above and the transmitter A, which maintains the connection to the control center, is extremely limited. This is especially the case if the transmitter is approved according to the ignition protection type intrinsic safety 60079-11. This standard imposes strong limitations on performance.

Conventionally, this is achieved by integrating resistors in transmitter A or transmitter B (or both) to reduce the transfer current. However, this leads to considerable losses and significantly reduced energy efficiency as well as reduced functionality.

The embodiments described herein significantly extend the possible installation length of the line for the connection between transmitters A and B. At the same time, these embodiments also make it possible to equip a remote measuring head with additional functions and a display. This is a significant advantage when servicing, installing and commissioning the transmitter. It also allows signals and power to be carried in one cable. This is a significant advantage, as safety installation regulations regarding separation and isolation are no longer required. Fuses that are traditionally installed in the transmitter to limit power are also protected from accidental triggering.

The integrated additional electronic protection and thus the limitation of the transfer and fault currents between transmitters A and B also represents a considerable advantage because a buyer of the system can connect the remote measuring head itself since sparking is excluded in any case.

There are also specific advantages for applications with or in a pump module. Due to the strict normative boundary conditions, pumps for explosion-proof regions (due to their high performance) are often installed within a flameproof enclosure (IEC 60079-1). With this type of protection, servicing is not possible without clearing and shutting down entire systems, as the flameproof enclosure must be opened for maintenance purposes. Therefore, any contact with electronics can lead to the immediate ignition of an explosive atmosphere. In conventional applications with pumps, part of a system must be shut down during maintenance for reasons of explosion protection, which can lead to very high costs or production downtime.

The embodiments described herein would, for example, make it possible to provide a hot-pluggable pump module with an ignition protection type that allows replacement during operation. This could also allow a cost-effective and simple housing design for the final product.

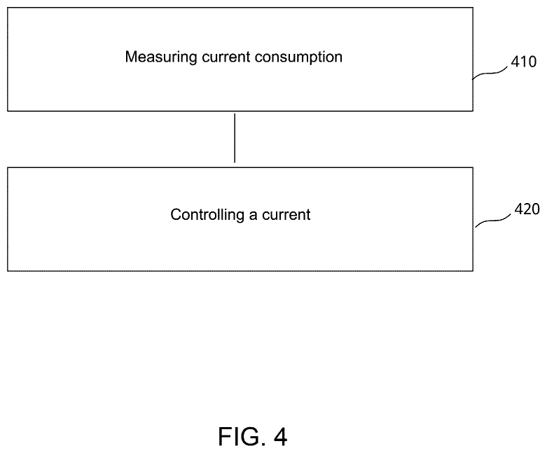

FIG. 4 shows a flowchart of an embodiment of a method for supplying power to a load module as described in the previous portions, for example with reference to FIG. 1.

The method includes measuring 410 a current consumption across an input terminal coupled to a power supply.

The method further includes controlling 420 a current through an output terminal based on the current consumption through the input terminal.

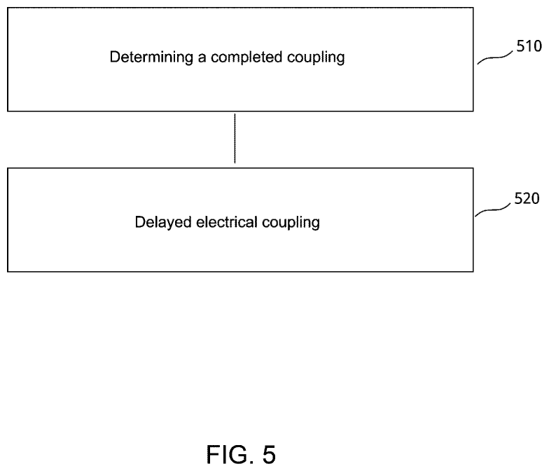

FIG. 5 shows a flowchart of an embodiment of a method for controlling a load as described in the previous portions, for example with reference to FIG. 2 and FIG. 3.

The method includes determining 510 whether an input terminal has been coupled to a power supply.

The method further includes a delayed electrical coupling 520 of the input terminal to an output terminal for coupling to the consumer after measuring the successful coupling to the power supply.

The aspects and features described together with one or more of the previously detailed examples and figures may also be combined with one or more of the other examples in order to replace a like feature of the other example or to additionally introduce the feature into the other example.

Examples may further include or relate to a computer program having program code for performing one or more of the above methods when the computer program is executed on a computer or processor. Steps, operations or processes of various methods described above may be performed by programmed computers or processors. Examples may also cover program storage devices, e.g., digital data storage media, that are machine-, processor-, or computer-readable and encode machine-executable, processor-executable, or computer-executable programs of instructions. The instructions perform or cause to be performed some or all of the steps of the methods described above. The program storage devices may include or be, for example, digital memories, magnetic storage media such as magnetic disks and magnetic tapes, hard disk drives, or optically readable digital data storage media. Further examples may also cover computers, processors, or control units programmed to perform the steps of the methods described above, or (field) programmable logic arrays ((F) PLAs or (field) programmable gate arrays ((F) PGA programmed to perform the steps of the methods described above.

The description and drawings illustrate only the principles of the disclosure. Furthermore, all examples provided herein are in principle expressly intended to serve only illustrative purposes to assist the reader in understanding the principles of the disclosure and the concepts contributed by the inventor(s) to advance the art. All statements herein concerning principles, aspects, and examples of the disclosure, as well as specific examples thereof, include their equivalents.

A functional block referred to as “means for . . . ” performing a particular function may refer to a circuit configured to perform a particular function. Thus, a “means for something” can be implemented as a “means designed for or suitable for something,” e.g., a component or circuit designed for or suitable for the particular task.

Functions of various elements shown in the figures, including any functional blocks referred to as “means,” “means for providing a signal,” “means for generating a signal,” etc., may be implemented in the form of dedicated hardware, e.g., “of a signal provider,” “of a signal processing unit,” “of a processor,” “of a control unit,” etc., as well as hardware capable of executing software in conjunction with associated software. When provided by a processor, the functions may be provided by a single dedicated processor, by a single shared processor, or by a plurality of individual processors, some or all of which may be shared. However, the term “processor” or “control unit” is by no means limited to hardware capable of executing software only, but can include digital signal processor (DSP) hardware, network processor, application-specific integrated circuit (ASIC), field-programmable gate array (FPGA), read-only memory (ROM) for storing software, random access memory (RAM), and non-volatile storage. Other hardware, conventional and/or customized, may also be included.

For example, a block diagram may represent a rough circuit diagram that implements the principles of the disclosure. Similarly, a flowchart, process chart, state transition diagram, pseudocode, and the like may represent various processes, operations, or steps that are for example substantially represented in computer-readable medium and thus performed by a computer or processor, regardless of whether such a computer or processor is explicitly shown. Methods disclosed in the description or in the claims may be implemented by a component having means for performing each of the respective steps of those methods.

It is understood that the disclosure of multiple steps, processes, operations, or functions disclosed in the description or claims should not be construed as being in that particular order unless explicitly or implicitly indicated otherwise, e.g., for technical reasons. Therefore, the disclosure of multiple steps or functions does not limit them to a particular order, unless these steps or functions are not interchangeable for technical reasons. Furthermore, in some examples, a single step, function, process, or operation may include and/or be broken down into multiple sub-steps, functions, processes, or operations. Such sub-steps may be included and form part of the disclosure of that individual step unless they are explicitly excluded.

Furthermore, the following claims are hereby incorporated into the detailed description, where each claim may stand on its own as a separate example. While each claim may stand on its own as a separate example, it should be noted that although a dependent claim may refer to a particular combination with one or more other claims in the claims, other examples may also include a combination of the dependent claim with the subject matter of any other dependent or independent claim. Such combinations are explicitly suggested here unless it is stated that a particular combination is not intended. Furthermore, features of a claim are intended to be included for any other independent claim, even if that claim is not made directly dependent on the independent claim.

### LIST OF REFERENCE SIGNS

100 supply device
110 input terminal
120 output terminal
130 measuring device
140 drive unit
150 control unit
200 load module
210 input terminal (load module)
220 output terminal (load module)
230 switching device
240 control unit (load module)
250 capacitor
260 electrical resistor
410 measuring
420 controlling
510 determining a coupling
520 delayed electrical coupling

1.-7. (canceled)

8. A load module for supplying a load, the load module comprising:
an input terminal for coupling to a power supply;
an output terminal for coupling to the load;
a switching device for providing variable electrical coupling of the input terminal to the output terminal; and
a control unit coupled to the switching device and configured to control an electrical coupling of the input terminal to the output terminal after the load module has been connected to the power supply via the switching device,
wherein the control unit is further configured to allow a current flow, using a switched transistor, only in one direction.

9. The load module of claim 8,
wherein the control unit is further configured to perform a delayed electrical coupling of the input terminal with the output terminal after coupling the input terminal to the power supply via the switching device.

10. The load module of claim 9,
wherein the control unit is further configured to perform the delayed electrical coupling of the input terminal with the output terminal based on a charge state of a capacitor.

11. The load module of claim 10,
wherein the capacitor is charged via a limited current after the coupling the input terminal to the power supply.

12. The load module of claim 10,
wherein the switching device is bridged with an electrical resistor in order to charge the capacitor.

13. The load module of claim 10,
wherein the control unit is configured to:
switch the switching device to a high impedance when the coupling the input terminal to the power supply takes place; and
switch the switching device to a low impedance when a voltage of the capacitor exceeds a predefined threshold value.

14. The load module of claim 10,
further comprising the load coupled to the output terminal,
wherein the load comprises at least one of:
a pump module, or
a measuring head for gases.

15. The load module of claim 14,
wherein the load module is encapsulated in a flameproof enclosure.

16. The load module of claim 14,
wherein the load module is configured for use in an explosive atmosphere.

17. A method for supplying power to a load module, comprising the steps of:
measuring a current consumption across an input terminal coupled to a power supply;
controlling a current across an output terminal based on the current consumption;
determining a successful coupling of an input terminal of the load module to a power supply; and
delaying electrical coupling of the input terminal to an output terminal of the load module, for coupling to a consumer, after measuring the successful coupling of the input terminal to the power supply.

18. The method of claim 17,
wherein the delaying comprises delaying the electrical coupling until a capacitor coupled to the power supply reaches a specified charge state.

19. The method of claim 17,
wherein the delaying comprises delaying the electrical coupling for a predetermined period of time.

20. The method of claim 17,
wherein:
the measuring the current consumption is performed using a measuring device coupled to a drive unit, and
the controlling the current is performed using the drive unit and a control unit coupled to the measuring device.

21. The method of claim 17, further comprising:
charging, after the successful coupling, a capacitor of the power supply via a limited current.

22. The method of claim 21,
wherein the charging the capacitor is based on an electrical resistor bridging a switching device coupled to a control unit configured for the controlling the current.

23. The method of claim 17,
wherein the controlling the current comprises causing, via a control unit and using a switched transistor, a current flow only in one direction.

24. The method of claim 17,
wherein a load of the load module is coupled to the output terminal, wherein the load comprises at least one of:
a pump module, or
a measuring head for gases,
wherein the method further comprises encapsulating the load module in a flameproof enclosure.

25. The method of claim 17,
wherein the controlling the current comprises causing, via a control unit:
switching a switching device to a high impedance when the coupling the input terminal to the power supply takes place; and
switching the switching device to a low impedance when a voltage of a capacitor of the power supply exceeds a predefined threshold value.

26. The method of claim 17, wherein the measuring the current consumption comprises measuring the current consumption using one or more of:
a shunt resistor,
a current mirror,
a Hall effect sensor, or
an integrated circuit.

27. The method of claim 17, wherein the controlling the current comprises controlling the current using one or more of:
a relay,
a transistor, or
a gate turn-off thyristor.
